(19) United States
(12) Patent Application Publication
(10) Pub. No.: US 2003/0158767 A1
(43) Pub. Date: Aug. 21, 2003

(54) Method and system for adaptive software system interface and external database synchronization

(76) Inventors: John I. Nwafor, Dallas, TX (US); Chijoke Mgbokwere, Plano, TX (US)

Correspondence Address: JENKENS & GILCHRIST, PC, 1445 ROSS AVENUE, SUITE 3200, DALLAS, TX, 75202, US

(21) Appl. No.: 10/330,158

(22) Filed: Dec. 27, 2002

Related U.S. Application Data
(60) Provisional application No. 60/344,413, filed on Dec. 28, 2001.

(51) Int. Cl. G06F 17/60

(52) U.S. Cl. 705/7

(57) ABSTRACT

Method and system for interfacing with one or more business systems having different data formats and different data entry states using a single interface system, and for synchronizing a database of a large business system, such as an enterprise resource planning system that does not itself provide for database synchronization functionality, with an external database.

This application claims the benefit of co-pending U.S. provisional patent application Ser. No. 60/344,413 filed on Dec. 28, 2001.

### BACKGROUND OF THE INVENTION

1. Field of the Invention

The present invention relates generally to the field of large business systems, for example, Enterprise Resource Planning (ERP) systems; and, more particularly, but not by way of limitation, to a method and system for interfacing with one or more large business systems and for synchronizing a database of large business system with an external database.

2. Description of Related Art

It is often necessary to interface with large business systems that have different data formats and different data entry states. Current industry practice is to engage consultants to develop customized solutions to particular interfacing problems. Such a practice is costly and rather inefficient inasmuch as each interfacing problem must be approached and solved separately.

Another problem that is often encountered in connection with large business systems concerns the synchronization of a database of the business system with an external database. In particular, a business system may not itself provide synchronization functionality; and in order to synchronize with a database of such a system, for example, to allow web-based applications to access the database, it may be necessary to replicate the entire database using standard database replication procedures. Thus, when an external database needs to be updated in addition to the database of the business system, it may be necessary to perform such replication procedures on a basis that does not support real time access to the database.

Furthermore, in applications where database replication cannot be provided, it may be necessary to directly interface with the business system database for such external purposes where real time updates are required, such that a large number of database queries may be incurred by the business system database server. When this occurs, the functioning of the business system may be slowed down significantly in order to process the external queries.

There is, accordingly, a need for techniques for interfacing with one or more business systems having different data formats and different data entry states using a single interface system, and for providing database synchronization functionality in business systems that do not themselves provide for such functionality.

### SUMMARY OF THE INVENTION

The present invention provides a method and system for interfacing with one or more business systems having different data formats and different data entry states, and for synchronizing a database of a business system with an external database.

According to an exemplary embodiment of the present invention, a system for interfacing with one or more business systems comprises a business process system for receiving business process data, and an interface system coupled to the business process system and the one or more business systems. The interface system includes a translator coupled to the business process system for receiving the business process data, for selecting one or more of the business systems based on the business process data, and for translating the business process data into business system data according to one or more rules, a state translator coupled to the translator for receiving the independent system data and for configuring the independent system data into state data using the one or more rules, and a translator configurer for querying the one or more business systems and for determining if the one or more rules are valid.

The interfacing system according to the present invention allows one or more independent business systems having different data formats and different data entry states to be interfaced with using a single interfacing system, resulting in a significant increase in efficiency and a substantial reduction in cost.

According to another exemplary embodiment of the present invention, a system for synchronizing a database of a business system with an external database is provided. The system comprises a database update monitor for receiving database entry timestamp data, for determining whether the database entry time stamp data is greater than a stored value, and for generating pointer data identifying a database entry; and an external database interface system coupled to the database update monitor, the external database interface system receiving the pointer data and transferring all database entries occurring after the pointer data to the external database.

The database synchronization system according to the present invention provides an effective means for providing database synchronization functionality for enterprise resource planning systems and other large business systems that do not themselves provide for such functionality.

### BRIEF DESCRIPTION OF THE DRAWINGS

The foregoing and other advantages of the invention will become apparent upon reading the following detailed description, when taken in conjunction with the following drawings, wherein:

FIG. 1 is a block diagram that schematically illustrates a system for interfacing with one or more business systems in accordance with an exemplary embodiment of the present invention;

FIG. 2 is a flowchart that illustrates a method for interfacing with one or more business systems in accordance with another exemplary embodiment of the present invention;

FIG. 3 is a block diagram that schematically illustrates a system for providing database synchronization functionality in a business system according to another exemplary embodiment of the present invention; and

FIG. 4 is a flowchart that illustrates a method for synchronizing a database of a business system with an external database in accordance with another exemplary embodiment of the present invention.

### DETAILED DESCRIPTION OF EXEMPLARY EMBODIMENTS OF THE INVENTION

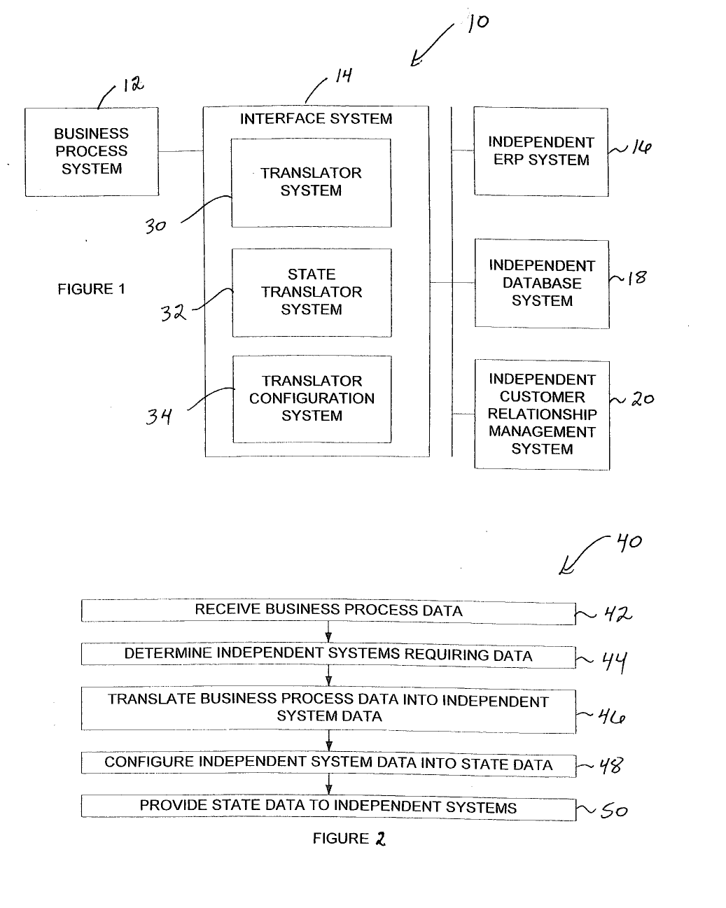

FIG. 1 is a block diagram that schematically illustrates a system for interfacing with one or more business systems in accordance with an exemplary embodiment of the present invention. The system is generally designated by reference number 10, and can be implemented in hardware, software or a combination of hardware and software; and can be one or more software systems operating on a general purpose server platform.

As illustrated in FIG. 1, system 10 includes a business process system 12 coupled to an interface system 14. Interface system 14 is, in turn, coupled to a plurality of independent business systems 16, 18 and 20. The term “coupled” as used herein can comprise a physical connection, such as a copper conductor, a virtual connection, such as through memory locations of a data memory device, a logical connection, such as through logical gates of a semiconductor device, or another suitable connection. In one exemplary embodiment of the invention, systems and components are coupled to other systems and components through intervening systems and components, such as through an operating system of a general purpose computing platform.

System 10 allows one or more independent business systems, such as systems 16, 18 and 20, having different data formats and different data entry states to be interfaced with using a single interfacing system. For example, as shown in FIG. 1, system 10 can be coupled to an independent Enterprise Resource Planning (ERP) system 16 such as an SAP R/3 system, a Peoplesoft system or a J D Edwards system; an independent database system 18 such as an Oracle database system; and an independent customer relationship management (CRM) system 20 such as a Siebel or Vantive CRM system. System 10 further allows one or more independent business systems to be interfaced with using a single interfacing system, even when the one or more independent business systems include prepackaged software that is in executable form only and for which the source code or user-readable code is not available.

Business process system 12 can use conventional programming language such as Java or C++, and can interface with each of independent business systems 16, 18 and 20 in a manner that allows additional interface processes to be performed or prepared using conventional programming languages where the data formats and data entry states for such independent business systems can be mapped. In this regard, a mapper, which may be a separate system or incorporated in the interface system 14, first maps data from the business process system 12 to an independent business system and then translates the data into the native language of the independent business system.

System 10 of FIG. 1 also allows versions of independent business systems to be controlled, so as to allow data that was stored for a first version of an independent business system to be used with subsequent versions of the independent business system. For example, the data generated through business process system 12 can include data extracted from an independent business system and processed for interfacing with one or more other independent business systems. In this manner, the business process system allows such data to be transparently processed even though versions of the independent business systems may have changed in the interim, where such versioning could also affect the ability to interface with the independent business system if interfacing was done with a system different from that illustrated in FIG. 1, such as where files compatible with an early version of a system are not directly compatible with a later version of the system.

Business process system 12 can implement suitable business processes such as financial and accounting processes, general ledger processes, accounts receivable processes, asset accounting processes, funds management processes, materials management processes, plant maintenance processes, service management processes, human resource processes or other suitable processes.

Interface system 14 includes translator system 30, state translator system 32 and translator configuration system 34. Systems 32, 34 and 36 receive data fields from business process system 12 and determine which of the independent business systems requires data based on the data received from business process system 12, the format of such data to be provided to such independent business systems, the data entry states required by such independent business systems and other appropriate information. In particular, translator system 30 receives business process data from the business process system, selects one or more of the independent business systems based on the business process data and translates the business process data into independent business system data according to one or more prescribed rules. State translator system 32 is coupled to translator system 30 and receives the independent business system data and configures the independent business system data into state data using the one or more rules. Translator configuration system 34 queries the one or more independent business systems and determines if the one or more rules are valid.

In one exemplary embodiment of the present invention, entry of project planning data through the business process system can include modification to each of an independent ERP system, an independent database system and an independent CRM system. In such exemplary embodiment, the translator system 30, the state translator system 32 and the translator configuration system 34 can identify the independent systems requiring the data, can format the data into a suitable format for entry into such independent systems, and can configure the data for each independent system based on the data entry states for each independent system. Likewise, when an independent business system generates data in response to such data entry, the translator system 30, the state translator system 32 and the translator configuration system 34 can receive that data and process it for provision to the business process system. In this manner, the business process system can be configured to provide functionality reports, processes or other suitable procedures that are independent of or different from the independent systems; the forms, reports, processes or other functions of the independent systems can be used in addition to those provided by the business process system; or other suitable processes can be implemented.

System 10 of FIG. 1 can also determine a configuration of the independent systems and determine whether that configuration has changed from a current configuration. In one exemplary embodiment, the independent systems can include one or more tables that store configuration data, such as data entry states, data field formats or other suitable configuration data. In the system of FIG. 1, for example, the translator configuration system 34 can determine whether changes have occurred, can implement modifications where possible to correct any differences, can generate notification data requesting an operator to correct the data entry configuration or sequence, if needed, or can perform other suitable functions. Translator configuration system 34 can also generate one or more rules for use by the translator system 30 and the state translator system 32, such as data format rules, data entry state rules, or other suitable rules.

According to another exemplary embodiment of the invention, interface system 14 includes a capability of reading the configuration of an independent business system in order to determine what is required by that system and what is optional in order to enable a particular business transaction to be performed. Interface system 14 can then use this information to determine in advance if the business process system can provide the required parameters. If not, the interface system can interrupt the interfacing process thus saving valuable resources. In effect, interface system 14 includes the capability of automatically reading the independent system configurations and then does the necessary translation so as to be able to tell the business process system what is required by the independent system and what is optional.

FIG. 2 is a flowchart that illustrates a method for interfacing with one or more independent business systems in accordance with a further exemplary embodiment of the present invention. The method is generally designated by reference number 40 and begins when business process data is received (step 42). The business process data can include, for example, data for creation or modification of standard business forms such as purchase orders, sales orders, pricing data, accounting data, invoicing data or other suitable business forms or processes.

The method then proceeds to step 44 where independent business systems that require the data are determined. In one exemplary embodiment of the present invention, one or more independent business systems may require sales order data, purchase order data, pricing data, accounting data, invoicing data or other suitable data.

After the independent business systems requiring the data are determined, such as by using predetermined rules that identify such systems, the method proceeds to step 46 where the business process data is translated into independent business system data. In one exemplary embodiment of the invention, the independent business system data can include predetermined data formats, fields, structures or other suitable data, and can further include mapping between versions of such independent business systems.

The method then proceeds to step 48 where the independent business system data is configured into state data. In one exemplary embodiment, the independent business systems can include one or more input data states, such as to require a user to enter a first account number, then to enter a user name, an amount number, an item number or other suitable states.

After the independent system data is configured into state data in step 48, the method proceeds to step 50 where the data state is provided to the independent business systems. In one exemplary embodiment, the state data can be provided to the independent business systems in a batch mode, in response to system prompts or in another suitable manner. Likewise, data can be received from the independent business systems and provided back to the operator of a business process system. Furthermore, where functions of the independent business systems can be determined using input from the independent business systems, such functions can be performed or selected based on the translator system, the state translator system, the translator configuration system or another suitable system.

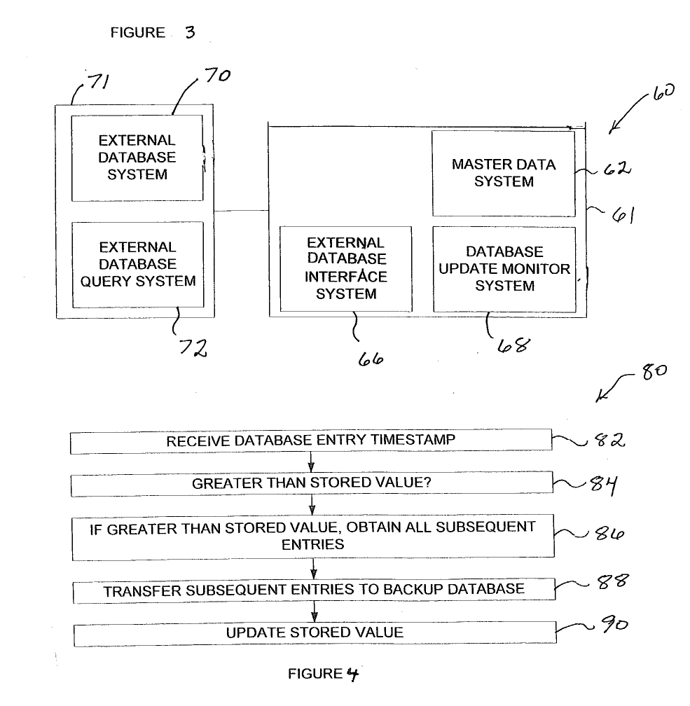

FIG. 3 is a block diagram that schematically illustrates a system for providing database synchronization functionality in a business system, such as an enterprise resource planning system, in accordance with a further exemplary embodiment of the present invention. The system is generally designated by reference number 60 and can be implemented in hardware, software or a suitable combination of hardware and software, and can be one or more software systems operating on a general purpose server platform.

Database synchronization system 60 allows ongoing database synchronization to be provided for an ERP system or to another large business system that does not itself provide for such functionality. In one exemplary embodiment of the invention, an ERP system 61 can be an SAP R/3 system, such as one that has programming and macro writing functionality for use within elements of the system, such as database servers, application servers, presentation servers or other suitable elements. Such ERP systems can include a database 62 such as in a database server that can be backed up using traditional database replication processes. Nevertheless, for synchronizing such databases, for example, to allow web-based applications to access the database, or for other purposes, it may be necessary to replicate the entire database using standard database replication processes. Thus, when an external database 70 of an external system 71 needs to be updated, in addition to such internal databases of ERP systems, it may be necessary to perform such database replication on a basis that does not support real time access to the database. Otherwise, if database replication or backup cannot be provided, it may be necessary to directly interface with the ERP databases for such external purposes when where real time updates are required, such that a large number of database queries may be incurred by the ERP database server or other system. When this occurs, the functioning of the ERP system can be slowed down to enable such external queries to be processed.

In order to avoid such slowdown of processes, an external database interface system 66 and a database update monitor system 68 are provided that allow database updates to be monitored and for updates to be provided to an external database system 70. For example, database update monitor system 68 can track a time of a last database update, and can monitor a pointer location of a database entry or other suitable database time stamp or time tracking or entry tracking procedure, and can provide updates since the date or time of the last update based in response to a periodic update schedule, in response to queries generated periodically by an external database query system 72 to external database interface system 66 or in another suitable manner. Thus, database update monitor system 68 can retrieve data that has been added to the database since the time of the last database update and synchronization, and can transfer that data to external database system 70, such as through external database interface system 66 or external database query system 72 or a suitable combination of the two.

FIG. 4 is a flowchart that schematically illustrates steps of a method for synchronizing a database of a business system, such as an ERP system, with an external database according to another exemplary embodiment of the present invention. The method is generally designated by reference number 80, and begins when a database entry time stamp data is received (step 82). The time stamp data can include a date and time, an update data sequence number, or other suitable data that indicates a point and time when the database is updated. Likewise, database time data can be generated by the process for each data update where such functionality is not provided by the system.

The method then proceeds to step 84 where it is determined whether the time entry stamp data is greater than a stored value. In one exemplary embodiment, the stored value can be a periodic data value generated by a system, can be provided by an external system in response to a stored value of that external system, or can be provided by some other suitable process.

The method then proceeds to step 86 where it is determined whether the stored value is greater than the time stamp value; and, if so, all subsequent entries between the last update and the current update are obtained, such as by querying the ERP system, extracting data from a buffer file or by another suitable process.

The method then proceeds to step 88 where the subsequent entries are transferred to a backup database. The external database is then updated to reflect the state of the main database. Such external database can be used for web interfacing, for user interfacing where update of the database is not required, or in another suitable manner.

The method then proceeds to step 90 where the stored value is updated, such as to allow the next set of update data to be determined so that previous sets of update data are not replicated.

While what has been described herein constitute exemplary embodiments of the invention, it should be recognized that the invention can be varied in many respects without departing from the scope thereof Because the invention can be varied in numerous ways, it should be understood that the invention should be limited only insofar as is required by the scope of the following claims.

We claim

1. A system for interfacing with one or more business systems, comprising:
a business process system for receiving business process data; and
an interface system coupled to said business process system and to said one or more business systems, said interface system comprising:
a translator coupled to said business process system for receiving the business process data, for selecting one or more of the independent business systems based on the business process data and for translating the business process data into independent system data according to one or more rules;
a state translator coupled to the translator for receiving the independent system data and for configuring the independent system data into state data using said one or more rules; and
a translator configurer for querying the one or more independent business systems and determining if said one or more rules are valid.

2. The system according to claim 1, wherein said business process system includes one or more of a financial accounting and control system, a general ledger system, an accounts receivable system, an asset accounting system, a special-purpose ledger system, a funds management system, a cash management system, a cash budget management system, an overhead cost control system, a product cost control system, a sales and distribution system, a materials management system, a plant maintenance system, a service management system, a production planning system, and a human resources system.

3. The system according to claim 1, wherein said translator configuration system interfaces with one or more tables in each business system and determines a row and column of business system data format data and business system state data.

4. The system according to claim 1, wherein said one or more business systems comprises one or more of an independent enterprise resource planning system, an independent database system and an independent customer relationship management system.

5. A method for interfacing with one or more business systems, comprising:
receiving business process data;
determining which of said one or more business systems should receive the business process data based on the business process data;
translating the business process data into business system data using one or more rules;
configuring the business system data into state data using the one or more rules; and
providing the state data to the one or more business systems.

6. The method according to claim 5, further comprising querying the one or more business systems to determine whether the one or more rules are valid.

7. The method according to claim 5, further comprising:
querying one or more tables in each of the one or more business systems to determine a row and column of business system data format data and business system state data;
retrieving the business system data format data and the business system state data and comparing them to rules data; and
storing modified business system data format data or modified business system state data if either the business system data format data or the business system state data, respectively, do not correlate to the rules data.

8. A system for synchronizing a database of a business system with an external database, comprising:
a database update monitor for receiving database entry timestamp data, for determining whether the database entry time stamp data is greater than a stored value, and for generating pointer data identifying a database entry; and
an external database interface system coupled to said database update monitor, said external database interface system receiving the pointer data and transferring all database entries occurring after the pointer data to the external database.

9. The system according to claim 8, further comprising an external database query system for generating a database monitor query at a predetermined interval, wherein the database update monitor receives the database monitor query and determines whether the database entry timestamp data is greater than a stored value and generates the pointer data identifying a database entry in response tot he database monitor query.

10. The system according to claim 8, wherein said business system comprises an enterprise resource planning system.

11. The system according to claim 10, wherein the database update monitor operates on an SAP R/3 database server.

12. A method for synchronizing a database of a business system with an external database, comprising:
receiving database entry time stamp data;
determining whether the database entry time stamp data is greater than a stored value;
generating pointer data identifying a database entry;
receiving the pointer data; and
transferring all database entries occurring after the pointer data to the external database.

13. The method according to claim 12, further comprising:
generating a database monitor query at a predetermined interval;
receiving the database monitor query;
determining whether the database entry timestamp data is greater than a stored value; and
generating the pointer data identifying a database entry in response to the database monitor query.

14. The method according to claim 12, wherein receiving the database entry time stamp data comprises receiving the database entry timestamp data from an SAP R/3 database server.
